(19) United States
(12) Patent Application Publication
(10) Pub. No.: US 2008/0036934 A1
(43) Pub. Date: Feb. 14, 2008

(54) LIQUID CRYSTAL DISPLAY AND METHOD OF DRIVING THE SAME

(76) Inventors: Yoon-Sung UM, Yongin-si (KR); Ji-Won Sohn, Seoul (KR); Jin-Won Park, Suwon-si (KR); Kang-Woo Kim, Seoul (KR); Seon-Ah Cho, Busan-city (KR)

Correspondence Address: F. CHAU & ASSOCIATES, LLC, 130 WOODBURY ROAD, WOODBURY, NY, 11797, US

(21) Appl. No.: 11/834,832

(22) Filed: Aug. 7, 2007

(30) Foreign Application Priority Data
Aug. 14, 2006 (KR) 2006-76829

(51) Int. Cl. G02F 1/133

(52) U.S. Cl. 349/38

(57) ABSTRACT

A liquid crystal display includes a gate driver generating a gate voltage including a gate on voltage and a gate off voltage, wherein the gate on voltage is applied for a first sub-frame and the gate off voltage is applied for a second sub-frame for at least one frame period, a data driver generating a data voltage, a plurality of gate lines sequentially receiving the gate voltage from the gate driver, a plurality of data lines receiving the data voltage from the data driver and insulated from the gate lines while crossing the gate lines, and a plurality of pixels formed on intersection areas of the gate lines and the data lines. Each of the pixels include a switching device operated by the gate voltage, a liquid crystal capacitor formed between a pixel electrode connected to the data line through the switching device and a common electrode corresponding to the pixel electrode, and a storage capacitor formed between a previous gate line and the pixel electrode, wherein a pixel electrode voltage applied to the pixel electrode is changed by the gate off voltage that is input to the previous gate line during the second sub-frame of the at least one frame period.

### CROSS-REFERENCE TO RELATED APPLICATION

This application claims priority to Korean Patent Application No. 2006-76829, filed on Aug. 14, 2006, the contents of which are herein incorporated by reference in their entirety.

### BACKGROUND OF THE INVENTION

1. Technical Field

The present disclosure relates to a liquid crystal display and a method of driving the same. More particularly, the present disclosure relates to an impulsive driving type liquid crystal display and an impulsive driving method for the liquid crystal display.

2. Discussion of Related Art

In general, a liquid crystal display (LCD) includes two panels and a liquid crystal layer having dielectric anisotropy interposed therebetween. The LCD applies an electric field to the liquid crystal layer and adjusts the intensity of the electric field to control the light transmittance through the liquid crystal layer, thereby realizing images on the display.

A liquid crystal display is one of the most widely used flat panel display devices. For example, thin film transistor LCDs (TFT-LCD) are commonly used for flat panel televisions, notebook computers, desktop computers, and mobile terminals such as a cellular phone or PDA (Personal Digital Assistant).

In LCDs, a low response speed of liquid crystal a blurring phenomenon that makes an image contour unclear can occur. To prevent the image blurring phenomenon, an impulsive driving method, which inserts a black image between normal images for a short period of time, has been utilized.

An impulsive driving method may include a cyclic resetting scheme in which a black data voltage corresponding to a black image is applied to pixels at a predetermined interval together with the normal data voltages relating to the display of images.

However, with an impulsive driving method, the insertion of the black image during the predetermined interval may require an additional circuit in the liquid crystal display. For example, in the case of a liquid crystal display driven at 120 Hz, a complicated circuit design may be required, thereby increasing the product cost and decreasing the yield rate.

### SUMMARY OF THE INVENTION

In an exemplary embodiment of the present invention, a liquid crystal display includes a gate driver generating a gate voltage including a gate on voltage and a gate off voltage, wherein the gate on voltage is applied for a first sub-frame and the gate off voltage is applied for a second sub-frame for at least one frame period, a data driver generating a data voltage, a plurality of gate lines sequentially receiving the gate voltage from the gate driver, a plurality of data lines receiving the data voltage from the data driver and insulated from the gate lines while crossing the gate lines, and a plurality of pixels formed on intersection areas of the gate lines and the data lines. Each of the pixels include a switching device operated by the gate voltage, a liquid crystal capacitor formed between a pixel electrode connected to the data line through the switching device and a common electrode corresponding to the pixel electrode, and a storage capacitor formed between a previous gate line and the pixel electrode, wherein a pixel electrode voltage applied to the pixel electrode is changed by the gate off voltage that is input to the previous gate line during the second sub-frame of the at least one frame period.

In an exemplary embodiment of the present invention, a method of driving a liquid crystal display includes dividing a single frame into a first sub-frame and a second sub-frame, generating a gate voltage, wherein the gate voltage includes a gate-on voltage applied for the first sub-frame and a gate-off voltage applied for the second sub-frame for at least one frame period, generating a data voltage, providing a plurality of data lines with the data voltage, and driving a plurality of pixels formed at intersection areas of the gate lines and the data lines using the data voltage and the gate on voltage. The step of driving each pixel includes providing each pixel with the gate on voltage, providing the data voltage and a common voltage to charge a liquid crystal capacitor including a pixel electrode and a common electrode, and charging and discharging a storage capacitor by providing the gate off voltage to a previous gate line, wherein the storage capacitor includes the previous gate line and the pixel electrode, and wherein a pixel electrode voltage applied to the pixel electrode is input to the previous gate line for the second sub-frame and is changed by the gate off voltage of the at least one frame period.

### BRIEF DESCRIPTION OF THE DRAWINGS

The present invention will become readily apparent to those of ordinary skill in the art when descriptions of exemplary embodiments thereof are read with reference to the accompanying drawings.

FIG. 1 is a block diagram of a liquid crystal display according to an exemplary embodiment of the present invention.

FIG. 2 is an equivalent circuit diagram showing one pixel of the liquid crystal display of FIG. 1, according to an exemplary embodiment of the present invention.

FIG. 3 is a layout view showing a previous gate structure applied to the liquid crystal display of FIG. 1.

FIG. 4 is a waveform diagram showing waveforms of a gate off voltage applied to a previous gate line and a pixel electrode voltage of a pixel electrode connected to a current gate line, according to an exemplary embodiment of the present invention.

FIG. 5 is a waveform diagram showing a waveform of a gate off voltage according to an exemplary embodiment of the present invention.

FIG. 6 is a flowchart illustrating a method of driving the liquid crystal display of FIG. 1, according to an exemplary embodiment of the present invention.

### DESCRIPTION OF EXEMPLARY EMBODIMENTS

Hereinafter, exemplary embodiments of the present invention will be described in detail with reference to the accompanying drawings. Like reference numerals refer to similar or identical elements throughout the description of the figures.

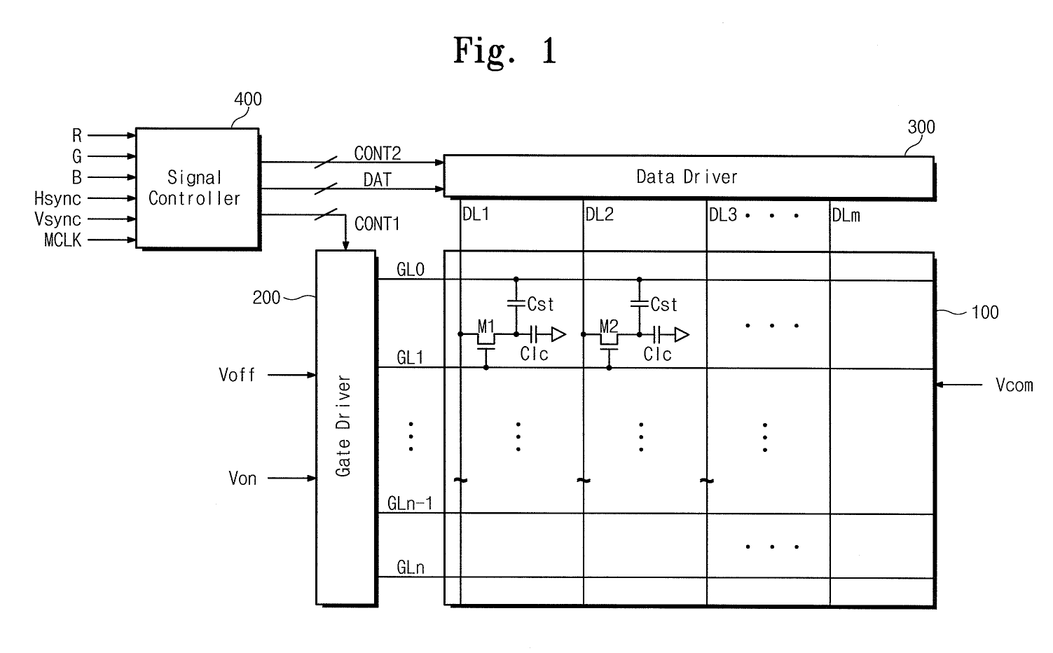

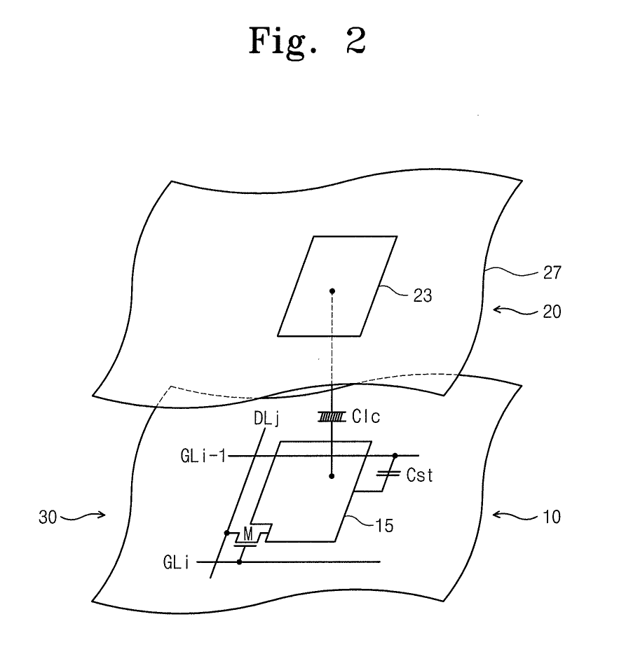

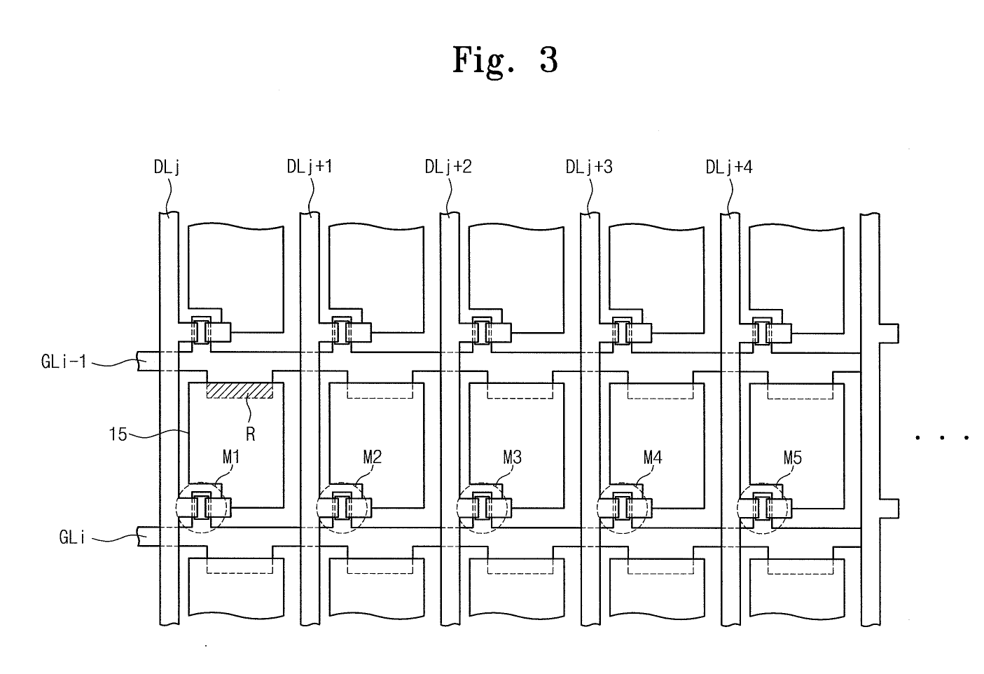

FIG. 1 is a block diagram of a liquid crystal display according to an exemplary embodiment of the present invention. FIG. 2 is an equivalent circuit diagram showing one pixel of the liquid crystal display of FIG. 1, according to an exemplary embodiment of the present invention. FIG. 3 is a layout view showing a previous gate structure applied to the liquid crystal display of FIG. 1.

Referring to FIGS. 1 through 3, the liquid crystal display includes a liquid crystal display panel 100, a gate driver 200 and a data driver 300, which are connected to the liquid crystal display panel 100, and a signal controller 400 controlling the gate and data drivers 200 and 300. Although not shown in FIG. 1, the liquid crystal display may include a gray-scale voltage generator connected to the data driver 300.

The liquid crystal display panel 100, which is provided with a plurality of display signal lines and a plurality of pixels connected to the signal lines, includes a lower display panel 10, an upper display panel 20 and a liquid crystal layer 30 interposed between the lower and upper display panels 10 and 20.

The display signal lines include a plurality of gate lines GL0-GLn and a plurality of data lines DL1-DLm. The gate lines GL0-GLn may be extended in the row direction and arranged substantially parallel to each other. The data lines DL1-DLm may be extended in the column direction and arranged substantially parallel to each other while being insulated from the gate lines GL0-GLn.

The gate lines GL0-GLn sequentially receive a gate voltage that includes a gate on voltage Von and a gate off voltage Voff outputted from the gate driver 200.

The gate on voltage Von is input into a selected gate line GLi and turns on the switching devices M1, M2, M3, . . . , Mn connected to the gate line GLi.

The gate off voltage Voff, which is applied after the gate on voltage Von has been applied, turns off the switching devices M1, M2, M3, . . . , Mn connected to the gate line GLi.

In this case, the gate off voltage Voff has an AC voltage waveform swinging for one period between two predetermined voltage levels. Details thereof will be described later in this disclosure.

Each pixel is provided with a switching device M connected to the display lines GLi and DLj. Each pixel includes a liquid crystal capacitor Clc and a storage capacitor Cst that are electrically connected to the switching device M.

The switching device M is a three-terminal element disposed in the lower display panel 10. A control terminal and an input terminal of the switching device M are electrically connected to the gate line GLi and the data line DLj, respectively, and an output terminal of the switching device M is electrically connected to the liquid crystal capacitor Clc and storage capacitor Cst, for example, as shown in FIGS. 1 and 2.

In an exemplary embodiment of the present invention described in connection with FIG. 2, the switching device M is a MOS transistor. The MOS transistor may be realized as a thin film transistor having a channel layer, for example, including amorphous silicon or polysilicon.

The elements of the liquid crystal capacitor Clc include a pixel electrode 15 of the lower display panel 10 and a common electrode 23 of the upper display panel 20 as two terminals thereof, and the liquid crystal layer 30 interposed between the pixel electrode 15 and the common electrode 23 may serve as a dielectric substance.

The pixel electrode 15 is electrically connected to the switching device M and the common electrode 23 and receives a common voltage Vcom. The common electrode 23 may be formed on the entire surface of the upper display panel 20. Although not shown as such in FIG. 2, the common electrode 23 can be formed on the lower display panel 10. For example, the pixel electrode 15 and/or common electrode 23 can be fabricated in a linear shape or a bar shape.

As shown in FIG. 2, the storage capacitor Cst corresponding to the liquid crystal capacitor Clc is electrically connected between the pixel electrode 15 and a previous gate line GLi-1. Referring to FIG. 3, when a gate line GLi connected to the pixel electrode 15 is defined as a current gate line GLi, the storage capacitor Cst is formed in an overlap region R between the previous gate line GLi-1 and the pixel electrode 15.

A structure in which a portion of the previous gate line functions as an electrode of the storage capacitor Cst may be referred to as a “previous gate line structure”.

To realize a color display, each pixel may uniquely display one of the predetermined primary colors (space division), or each pixel may display the primary colors as a function of time (time division), such that desired colors can be displayed by the combination of the space division and time division. FIG. 2 shows an example of space division, in which color filters of red (R), green (G) or blue (B) color 27 are provided in areas corresponding to the pixel electrode 15 formed in the pixels. The color filter can be represented with four colors in which a white color is added to the three primary colors of light (red, green and blue). The three primary colors of cyan, magenta and yellow can be used independently or together with the three primary colors of light. The color filter can be formed above or below the pixel electrode 15 of the lower display panel 10.

A polarizer (not shown) may be attached to an outer surface of at least one of the lower display panel 10 or upper display panel 20 of the liquid crystal display panel 100 to polarize the light.

The gate driver 200, which is electrically connected to the gate lines GL0-GLn of the liquid crystal display panel 100, sequentially applies the gate voltage including the gate on voltage Von and the gate off voltage Voff to the gate lines GL0-GLn. The gate driver 200 may include a plurality of integrated circuits.

The data driver 300, which is electrically connected to the data lines DL1-DLm of the liquid crystal display panel 100, selects a gray-scale voltage from the gray-scale voltage generator (not shown) and applies the gray-scale voltage to the pixel. The data driver 300 includes at least one integrated circuit.

The gate driving integrated circuit or data driving integrated circuit can be formed on a chip and mounted on a tape carrier package (TCP), such that the TCP can be attached to the liquid crystal display panel 100. The integrated circuit chip can be directly attached to a glass substrate without using the TCP through application of chip on glass (COG) technology. A circuit having the function of the integrated circuit chip can be directly formed on the liquid crystal display panel 100 together with the thin film transistor of the pixel.

The signal control unit 400 controls the gate driver 200 and the data driver 300.

Hereinafter, operations of a liquid crystal display according to an exemplary embodiment of the present invention will be described in detail.

The signal control unit 400 receives input image signals R, G and B and input control signals controlling display of the input image signals R, G and B from an external graphic controller (not shown). For example, the control signals may include a vertical synchronization signal Vsync, a horizontal synchronization signal Hsync, a main clock MCLK, a data enable signal DE, etc.

The signal control unit 400 processes the image signals based on the input image signals R, G and B and the input control signal according to the operational conditions of the liquid crystal display panel 100 to generate a gate control signal CONT1 and a data control signal CONT2.

The gate control signal CONT1 includes a vertical synchronization start signal STV, which indicates an output start of the gate on voltage Von, and at least one clock signal controlling output time and output voltage of the gate on voltage Von.

The data control signal CONT2 includes a horizontal synchronization start signal STH indicating a start of transmission of an image data DAT, a load signal LOAD to apply the corresponding data voltage to the data lines DL1-DLm, an inverse signal RVS which inverts the polarity of the data voltage about the common voltage Vcom (hereinafter, the polarity of the data voltage about the common voltage is simply referred to as “the polarity of data voltage”), and a data clock signal HCLK.

The signal control unit 400 outputs the gate control signal CONT1 to the gate driver 200, and outputs the data control signal CONT2 and the processed image signal to the data driver 300.

The gate driver 200 applies the gate on voltage Von to the gate lines GL0-GLn according to the gate control signal CONT1 outputted from the signal control unit 400 so as to turn on the switching device M, which is electrically connected to the gate line GL0-GLn. Accordingly, the data voltage applied to the data lines DL1-DLm is applied to the corresponding pixels through the switching device M that has been turned on.

The data driver 300 sequentially receives and shifts the image data DAT for a row of pixels according to the data control signal CONT2 outputted from the signal control unit 400. The data driver 300 selects a gray voltage corresponding to the image data DAT from among the gray-scale voltages output from a gray-scale voltage generator (not shown), so as to convert the image data DAT into the corresponding data voltage, and then applies the data voltage to the corresponding data lines DL1-DLm.

The voltage difference between the common voltage Vcom and the voltage applied to the pixel electrode 15 (hereinafter, referred to as a pixel voltage) corresponds to the charge voltage of the liquid crystal capacitor Clc, that is, a pixel electrode voltage Vp.

The alignment of liquid crystal molecules in the liquid crystal layer 30 is changed depending on the intensity of electric field formed by the pixel electrode voltage Vp, so that the polarization of light passing through the liquid crystal layer 30 varies according to the pixel electrode voltage Vp. Such variation of the light polarization may be represented as transmission variation by means of a polarizer (not shown) attached to the lower display panel 10 and/or the upper display panel 20.

The gate driver 200 and the data driver 300 may repeat the same operations for a pixel of the next row in one horizontal period unit (or 1H, which is one period of the horizontal synchronization signal Hsync). In this way, the gate on voltage Von can be sequentially applied to all gate lines GL0-GLn for one frame, so that the data voltages are applied to all pixels. As one frame ends, the next frame starts, and the state of the inverse signal RVS applied to the data driver may be controlled such that the polarity of the data voltage applied to the pixel is opposed to the polarity of the data voltage applied to the pixel in the previous frame (frame inversion). At this time, the polarity of data voltage applied to one data line can be changed even in the same frame (row inversion, dot inversion), or the polarity of data voltage applied to the pixels aligned in the same row can be changed (column inversion, dot inversion), according to the characteristic of the inverse signal RVS.

Hereinafter, an impulsive driving method according to an exemplary embodiment of the present invention will be explained in detail with reference to operations of a liquid crystal display according to an exemplary embodiment of the present invention described in connection with FIGS. 1 through 3.

As mentioned above, the gate off voltage Voff may swing between two voltage levels, from the gate driver 200 to the previous gate line GLi-1.

The gate off voltage Voff swinging between two voltage levels changes the pixel electrode voltage Vp the pixel electrode connected to the current gate line GL1. A black image can be displayed on the display using the changed pixel electrode voltage Vp.

The dielectric constant of liquid crystal is changed according to the voltage applied thereto, and the capacitance of the liquid crystal capacitor Clc before/after the charge operation changes as a function of time. If no charge is input (e.g., a state in which all of the thin film transistors connected to the selected gate line are turned off), the amount of charge stored in the liquid crystal capacitor Clc should be constant over time, according to the charge conservation law. The pixel electrode voltage Vp of the pixel electrode may be changed to compensate for the changed capacitance of the liquid crystal capacitor Clc. For example, if C₀ represents the capacitance and V₀ represents the voltage across the liquid crystal capacitor Clc, and C(t) and V(t) represent the capacitance and the voltage after a predetermined time (t) has lapsed after the charge operation, then the charge Q can be expressed by the following equations.

Qo=CoVo EQUATION 1

Q(t)=C(t)V(t)=CoVo=Qo EQUATION 2

A liquid crystal display according to an exemplary embodiment of the present invention utilizes an impulsive driving scheme capable of displaying a black image on the display by changing the pixel electrode voltage Vp based on the principle of charge conservation.

The switching devices M1, M2, M3, . . . , Mn are turned on by the gate on voltage Von input into the selected gate line GLi from the gate driver 200, and the liquid crystal capacitor Clc and the storage capacitor Cst are charged to a predetermined value by the data voltage provided from the data driver 300.

After the liquid crystal capacitor Clc and the storage capacitor Cst are charged, the switching devices M1, M, M3, . . . , Mn connected to the selected gate line GLi are turned off by the gate off voltage Voff, which is applied after the gate on voltage Von. The capacitance of the liquid crystal capacitor Clc and the storage capacitor Cst are maintained during the turn-off operation of the switching devices M1, M2, M3, . . . , Mn.

At this time, the gate off voltage Voff swinging between the two voltage levels on the basis of a threshold voltage of the switching devices M1, M2, M3, . . . Mn is applied to the previous gate line GLi-1, which form the storage electrode of the storage capacitor Cst.

The capacitance of the storage capacitor Cst is changed according to the gate off voltage Voff voltage swing, and the total capacitance of the storage capacitor Cst and the liquid crystal capacitor Clc is changed.

The pixel electrode voltage Vp of the pixel electrode is changed to compensate for the changed total capacitance according to the charge conservation law.

In this case, if the variable voltage level of the gate off voltage changed on the basis of the threshold voltage is denoted as Voff′ and the voltage level of the pixel electrode voltage changed according to the gate off voltage is denoted as Vp′, the following equations can be derived from the Equations 1 and 2.

$$C l c ( {V}_{p} - {V}_{com} ) + C s t ( {V}_{p} - {V}_{off} ) = C l c ( {V}_{p}^{′} - {V}_{com} ) + C s t s ( {V}_{p}^{′} - {V}_{p}^{′} ) \qquad EQUATION 3$$

Equation 3 can be replaced with Equation 4.

$$( {V}_{p} - {V}_{p}^{′} ) = \frac{C s t}{C s t + C l c} ( {V}_{off} - {V}_{off}^{′} ) \qquad EQUATION 4$$

If Vp-Vp′ shown in the left side of Equation 4 is written as ΔVp, and Voff-Voff′ shown in the right side of equation 4 is written as ΔVoff, Equation 4 can be rearranged into Equation 5.

$$Δ V p = \frac{C s t}{C s t + C l c} Δ {V}_{off } \qquad EQUATION 5$$

As can be understood from Equation 5, variation ΔVp of the pixel electrode voltage Vp is determined according to the ratio between the capacitance of the liquid crystal capacitor Clc and that of storage capacitor Cst and the variation ΔVoff of the gate off voltage Voff.

Hereinafter, an impulsive driving scheme according to an exemplary embodiment of the present invention will be described in detail.

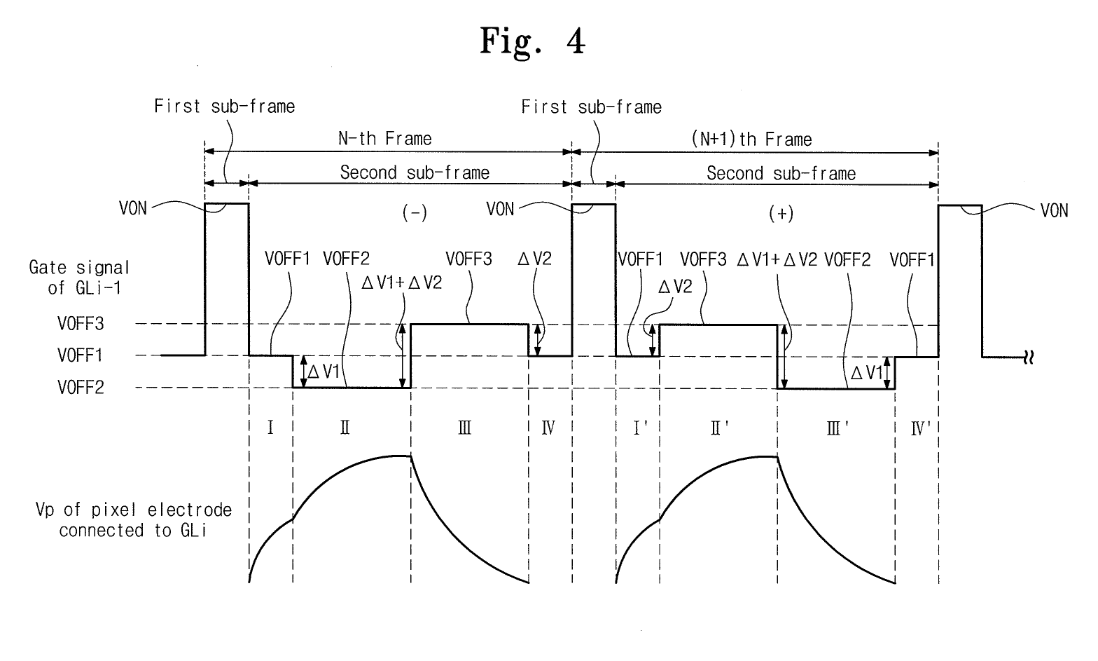

FIG. 4 is a waveform diagram showing waveforms of a gate off voltage applied to the previous gate line and the pixel electrode voltage Vp of the pixel electrode connected to the current gate line, according to an exemplary embodiment of the present invention.

According to an exemplary embodiment of the present invention, a liquid crystal display is driven as a normally black mode with the line inversion scheme, and two serial frames, in which the data voltage applied to the pixel electrode is inverted from negative polarity to positive polarity, are shown.

Referring to FIG. 4, the gate on voltage Von, which is applied to the previous gate line, is sequentially outputted from the gate driver 200 to the gate lines GL0-GLn according to the vertical synchronization start signal STV.

The gate lines GL0-GLn receive the gate on voltage Von and then receive the gate off voltage Voff. In an exemplary embodiment of the present invention, a frame is divided into a first sub-frame and a second sub-frame.

In the first sub-frame of N-th frame, the gate on voltage Von, for example, about 20V, which turns on the switching devices M1, M2, M3, . . . , Mn, is applied to the gate line GL1. In the second sub-frame, the gate off voltage Voff, which turns off the switching devices M1, M2, M3, . . . , Mn, is applied to the gate line GL1.

The gate off voltage Voff may be represented in the form of pulses of a DC voltage maintained at a first voltage level Voff1 and an AC voltage swinging between a second voltage Voff2 and a third voltage Voff3.

The first voltage level Voff1 corresponds to a threshold voltage that turns off a plurality of the switching devices. The second voltage level Voff2 and the third voltage level Voff3 respectively correspond to a minimum voltage level and a maximum voltage level that turn off the switching devices.

The absolute value of the voltage difference between the first voltage level Voff1 and the second voltage level Voff2 may be set to 5V or below. In an exemplary embodiment of the present invention, the absolute value of the voltage difference between the first voltage level Voff1 and the second voltage level Voff2 is set to about 3V.

The absolute value of the voltage difference between the first voltage level Voff1 and the third voltage level Voff3 is set to 5V or below. In an exemplary embodiment of the present invention, the absolute value of the voltage difference between the first voltage level Voff1 and the third voltage level Voff3 is set to about 3V. The voltage difference between the first voltage level Voff1 and the second voltage level Voff2 can be set different from or substantially equal to the voltage difference between the first voltage level Voff1 and the third voltage level Voff3.

Referring to FIG. 4, the second sub-frame of the N-th frame is divided into a first interval I in which the first voltage level Voff1 is applied, a second interval II in which the second voltage level Voff2 is applied, a third interval III in which the third voltage level Voff3 is applied and a fourth interval IV in which the first voltage level Voff1 is applied.

In the first interval I, the gate off voltage Voff, which is applied to the previous gate line GLi-1, is maintained at the first voltage level Voff1 corresponding to the threshold voltage of the switching device. In this case, the pixel electrode voltage Vp of the pixel electrode connected to the current gate line GL1 increases by the data voltage applied to the pixel electrode 15 from the data driver 300.

In the second interval I, the gate off voltage Voff, which is maintained at the first voltage level Voff1, is decreased by ΔV1, such that the gate off voltage Voff is maintained at the second voltage level Voff2. At this time, a negative voltage is applied to the pixel electrode 15 during the current frame (N-th frame), and the capacitance of the storage capacitor Cst increases due to the voltage variation ΔV1. The pixel electrode voltage Vp further increases due to the increase of the capacitance of the storage capacitor Cst.

In the third interval III, the gate off voltage Voff, which is maintained at the second voltage level Voff2 in the second interval II, is increased by ΔV1+ΔV2, such that the gate off voltage Voff is maintained at the third voltage level Voff3. At this time, a negative voltage is applied to the pixel electrode 15 during the current frame (N-th frame), and the capacitance of the storage capacitor Cst decreases due to the voltage variation ΔV1+ΔV2.

As a result, the pixel electrode voltage Vp is decreased near the level of the common voltage Vcom due to the decreased capacitance of the storage capacitor Cst. Thus, an image of black brightness level can be realized using the voltage variation of the pixel electrode ΔVp.

In the fourth interval IV, the gate off voltage Voff, which is maintained at the third voltage level Voff3, is decreased by ΔV2 so that the gate off voltage Voff is maintained at the first voltage level Voff1.

Then, the next frame (referred to herein as the (N+1)th frame) is processed. However, since the polarity is inverted at each frame in the liquid crystal display according to an exemplary embodiment of the present invention, the gate off voltage Voff having a phase opposite to the phase of the gate off voltage Voff in the N-th frame is applied to the second sub-frame of the (N+1)th frame.

That is, the voltage level of the gate off voltage Voff applied in a first interval I′ and a fourth interval IV′ of the (N+1)th frame is substantially equal to the voltage level of the gate off voltage Voff applied in the first interval I and the fourth interval IV in the N-th frame. The voltage level of a second interval II′ in the (N+1)th frame is changed so as to be maintained at the third voltage level Voff3, and the voltage level of a third interval III′ is changed so as to be maintained at the second voltage level Voff2. In this way, the waveform of the pixel electrode voltage Vp, which realizes the image of black brightness level at each frame, can be generated.

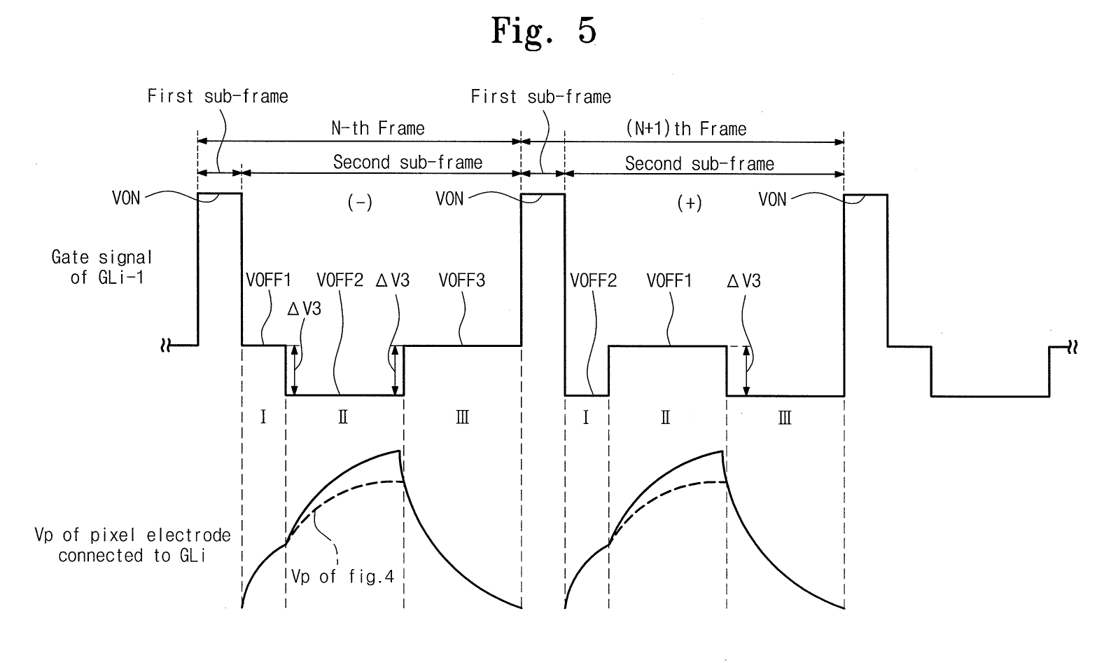

FIG. 5 is a waveform diagram showing a waveform of a gate off voltage according to an exemplary embodiment of the present invention. FIG. 5 shows two serial frames wherein the polarity of data voltage is inverted from negative polarity to positive polarity.

Referring to FIG. 5, the gate off voltage Voff is applied during the second sub-frame divided into three intervals. The second sub-frame is divided into a first interval I maintained at a first voltage level Voff1, a second interval I maintained at a second voltage level Voff2, and a third interval III maintained at the first voltage level Voff1.

In contrast to the gate off voltage Voff illustrated in FIG. 4, the gate off voltage Voff illustrated in FIG. 5 has two voltage levels, that is, a maximum voltage level (first voltage level) and a minimum voltage level, which are needed to turnoff the switching device M1, M2, M3, . . . , Mn.

In the first interval I, the gate off voltage Voff1 having a voltage level substantially equal to that of the gate off voltage Voff shown in FIG. 4 is applied.

Then, in the second interval II, the gate off voltage Voff is maintained at the second voltage level Voff2, which has decreased by ΔV3 from the first voltage level Voff1. At this time, the voltage variation ΔV3 is larger than the voltage variation ΔV1 shown in FIG. 4. Accordingly, the pixel electrode voltage Vp may increase with a higher rate as compared with that of the pixel electrode voltage Vp during the first and second intervals I and II shown in FIG. 4.

In the third interval III, the gate off voltage is maintained at the third voltage level Voff 3 which has been raised by ΔV3 from the second voltage level Voff2. In this case, the pixel electrode voltage Vp is decreased near the level of the common voltage Vcom due to the variation of the gate off voltage Voff which has been increased by ΔV3.

According to an exemplary embodiment of the present invention, the pixel electrode voltage increases in the second interval II with a rate higher than that of the pixel electrode voltage increased in the second interval II shown in FIG. 4.

For example, the pixel electrode voltage Vp is raised in the second interval II to a voltage level higher than the voltage level in the second interval II shown in FIG. 4, and then in the third interval III is decreased near the level of the common voltage. Therefore, the image of black brightness level for the impulsive driving scheme may be improved as compared with the image of the black brightness level in the FIG. 4.

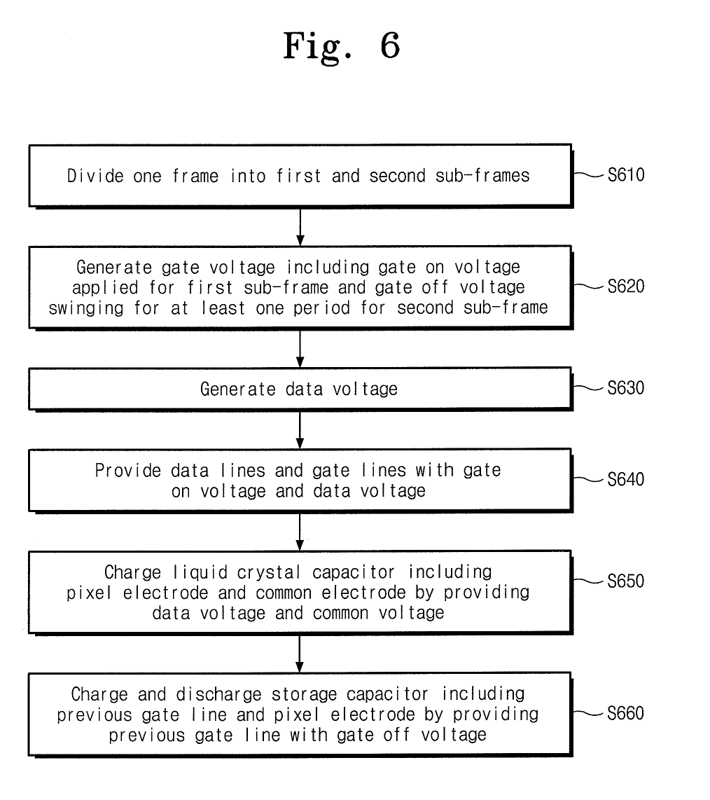

Hereinafter, a driving procedure for a liquid crystal display according to an exemplary embodiment of the present invention will be described with reference to FIG. 6.

FIG. 6 is a flowchart showing a driving procedure for a liquid crystal display according to an exemplary embodiment of the present invention.

Referring to FIG. 6, one frame is divided into a first sub-frame and a second sub-frame, in block S610.

Then, a gate voltage including a gate on voltage applied for the first sub-frame and a gate off voltage applied for the second sub-frame is generated, in block S620. In this case, the gate off voltage has an AC voltage pulse swinging for at least one period.

After that, a data voltage is generated, in block S630. Then pixels formed at intersection areas between gate lines and data lines are driven by the data voltage and the gate on voltage, in block S640.

To drive the pixels, the gate on voltage is applied to each pixel, in block S650, and the data voltage and common voltage are applied to charge a liquid crystal capacitor which includes a pixel electrode and a common electrode, in block S650. The storage capacitor including the previous gate line and the pixel electrode are charged and discharged by providing the previous gate line with the gate off voltage (i.e., the gate line connected to the pixel electrode is defined as the current gate line), in block S660.

The pixel electrode voltage Vp of the pixel electrode is changed due to the gate off voltage, which is input to the previous gate line for the second sub-frame while swinging for at least one period, so that the black image for the impulsive driving scheme can be displayed on the display.

According to an exemplary embodiment of the present invention, the liquid crystal display can change the pixel electrode voltage by using the gate off voltage having the AC voltage pulse form, realizing the black image on the display In an exemplary embodiment of the present invention, no additional data voltage for the impulsive driving scheme is required, and the circuit configuration in the liquid crystal display can be simplified and the product cost can be reduced.

Although the exemplary embodiments of the present invention have been described in detail with reference to the accompanying drawings for the purpose of illustration, it is to be understood that the inventive processes and apparatus should not be construed as limited thereby. It will be apparent to those of ordinary skill in the art that various modifications to the foregoing exemplary embodiments may be made without departing from the scope of the present invention as defined by the appended claims, with equivalents of the claims to be included therein.

What is claimed is:

1. A liquid crystal display comprising:
a gate driver generating a gate voltage including a gate on voltage and a gate off voltage wherein the gate on voltage is applied for a first sub-frame and the gate off voltage is applied for a second sub-frame for at least one frame period;
a data driver generating a data voltage;
a plurality of gate lines sequentially receiving the gate voltage from the gate driver;
a plurality of data lines receiving the data voltage from the data driver and insulated from the gate lines while crossing the gate lines; and
a plurality of pixels formed at intersection areas of the gate lines and the data lines,
wherein each of the pixels comprises:
a switching device operated by the gate voltage;
a liquid crystal capacitor formed between a pixel electrode connected to a corresponding data line of the data lines through the switching device and a common electrode corresponding to the pixel electrode; and
a storage capacitor formed between a previous gate line and the pixel electrode,
wherein, a pixel electrode voltage applied to the pixel electrode is changed by the gate off voltage that is input to the previous gate line during the second sub-frame of the at least one frame period.

2. The liquid crystal display of claim 1, wherein the gate off voltage comprises a direct voltage which is maintained at a first voltage level and an alternating voltage which is swinging between a second voltage level and a third voltage level.

3. The liquid crystal display of claim 2, wherein the second sub-frame comprises a first interval maintained at the first voltage level, a second interval maintained at the second voltage level, a third interval maintained at the third voltage level and a fourth interval maintained at the first voltage level.

4. The liquid crystal display of claim 3, wherein the first voltage level is a threshold voltage of the switching device, and
each of the second voltage level and the third voltage level is selected from a voltage range between a minimum voltage level and a maximum voltage level needed to turn off the switching device.

5. The liquid crystal display of claim 4, wherein,
when a negative data signal is applied to the pixel electrode through the data line, the second voltage level corresponds to the minimum voltage level which is needed to turn off the switching device and the third voltage level corresponds to the maximum voltage level needed to turn off the switching device, and
when a positive data signal is applied to the pixel electrode through the data line, the second voltage level corresponds to the maximum voltage level needed to turn off the switching device and the third voltage level corresponds to the minimum voltage level needed to turn off the switching device.

6. The liquid crystal display of claim 4, wherein an absolute value of a voltage difference between the first voltage level and the second voltage level is about 5V or less, and an absolute value of a voltage difference between the first voltage level and the third voltage level is about 5V or less.

7. The liquid crystal display of claim 3, wherein the pixel electrode voltage applied to the pixel electrode is continuously raised during the second interval and is decreased during the third interval near the level of a common voltage applied to the common electrode.

8. The liquid crystal display of claim 7, wherein an amount of charge in the storage capacitor increases during the second interval, and decreases during the third interval.

9. The liquid crystal display of claim 8, wherein, as the amount of charge in the storage capacitor increases, an amount of charge in the liquid crystal capacitor increases, and as the amount of charge in the storage capacitor decreases, the amount of charge in the liquid crystal capacitor decreases.

10. The liquid crystal display of claim 7, wherein variation of the pixel electrode voltage between the second and third intervals is defined by
$$∇ V p = \frac{C s t}{C l c + C s t} Δ V off$$
(wherein, Vp is variation of the pixel electrode voltage, Clc is capacitance of the liquid crystal capacitor, Cst is capacitance of the storage capacitor and Voff is variation of the gate off voltage between the second interval and the third interval).

11. The liquid crystal display of claim 10, wherein the variation of the pixel electrode voltage is determined according to the variation of the gate off voltage between the second and the third intervals.

12. The liquid crystal display of claim 1, wherein the gate off voltage comprises a direct voltage which is maintained at a first voltage level and an alternating voltage which is swinging between the first voltage level and a second voltage level, and
the second sub-frame comprises a first interval where the first voltage level is applied, a second interval where the second voltage level is applied and a third interval where the first voltage level is applied.

13. The liquid crystal display of claim 12, wherein each of the first voltage level and the second voltage level is selected from a voltage range between a minimum voltage level and a maximum voltage level needed to turn off the switching device.

14. The liquid crystal display of claim 13, wherein when a negative data signal is applied to the pixel electrode through the data line, the first voltage level corresponds to the maximum voltage level which is needed to turn off the switching device and the second voltage level corresponds to the minimum voltage level which is needed to turn off the switching device, and wherein when a positive data signal is applied to the pixel electrode through the data line, the first voltage level corresponds to the minimum voltage level which is needed to turn off the switching device and the second voltage level corresponds to the maximum voltage level which is needed to turn off the switching device.

15. The liquid crystal display of claim 13, wherein the pixel electrode voltage is continuously raised during the second interval and is decreased during the third interval near the level of a common voltage applied to the common electrode.

16. A method of driving a liquid crystal display, the method comprising:
dividing a single frame into a first sub-frame and a second sub-frame;
generating a gate voltage, wherein the gate voltage includes a gate on voltage applied for the first sub-frame and a gate off voltage applied for the second sub-frame for at least one frame period;
generating a data voltage;
providing a plurality of data lines with the data voltage; and
driving a plurality of pixels formed at intersection areas of the gate lines and the data lines using the data voltage and the gate on voltage,
wherein the step of driving each pixel comprises:
providing each pixel with the gate on voltage;
providing the data voltage and a common voltage to charge a liquid crystal capacitor including a pixel electrode and a common electrode; and
charging and discharging a storage capacitor by providing the gate off voltage to a previous gate line, wherein the storage capacitor includes the previous gate line and the pixel electrode,
wherein a pixel electrode voltage applied to the pixel electrode is input to the previous gate line for the second sub-frame and is changed by the gate off voltage of the at least one frame period.

17. The method of claim 16, wherein each pixel comprises a switching device operated by the gate voltage, and
the gate off voltage is represented in a form of an AC pulse which is swinging between a minimum voltage level and a maximum voltage level needed to turn off the switching device.

18. The method of claim 17, wherein
when a negative data signal is applied to the pixel electrode through the data line, the pixel electrode voltage is raised in the minimum voltage interval of the gate off voltage, and is decreased in the maximum voltage interval of the gate off voltage, and
when a positive data signal is applied to the pixel electrode through the data line, the pixel electrode voltage is raised in the maximum voltage interval of the gate off voltage, and is decreased in the minimum voltage interval of the gate off voltage.
